(19) United States
(12) Patent Application Publication
(10) Pub. No.: US 2011/0055678 A1
(43) Pub. Date: Mar. 3, 2011

(54) MULTIMEDIA SYSTEM FOR MOBILE DEVICES

(76) Inventor: JAMES DAVID RAMSEY, DELAWARE, OH (US)

(21) Appl. No.: 12/873,877

(22) Filed: Sep. 1, 2010

Related U.S. Application Data
(60) Provisional application No. 61/239,296, filed on Sep. 2, 2009.

(51) Int. Cl. G06F 17/00

(52) U.S. Cl. 715/202

(57) ABSTRACT

A system for use in conjunction with a mobile device. The system includes a pre-processor configured to receive input data from a plurality of multimedia sources, generate Extensible Markup Language output links relating to the input data, and generate outputs comprising at least one of images, thumbnails, and rich media. The outputs are assembled into a mobile device application.

This application claims priority to U.S. provisional patent application No. 61/239,296, filed Sep. 2, 2009, the entire contents of which are hereby incorporated by reference thereto.

### FIELD

The present invention relates generally to mobile devices, in particular to a system for use in conjunction with a mobile device such as a mobile telephone or personal digital assistant (PDA).

### BACKGROUND

Mobile telephones are becoming increasingly sophisticated, many now allowing computing applications to be loaded and run. For example, a range of mobile based games exists, some of which allow for collaborative gaming over the mobile network. Mobile applications are also being developed to allow users access to remote computer systems. Indeed, there is a drive towards allowing consumers to conduct banking activities using their mobile telephones. Another area where mobile applications are likely to be deployed may be productivity tools for corporate use, such as e-mail and schedule access, as well as tools to provide mobile sales staff with access into their corporate systems.

Despite the advances in the art, there remains a need for a system for use in conjunction with a mobile device that allows the mobile device to augment books such as printed textbooks, the mobile device functioning as an interactive learning aid and information resource.

### SUMMARY

A system for use in conjunction with a mobile device is disclosed according to an embodiment of the present invention. The system receives multimedia data as an input and generates a corresponding software-based application that is configured for installation into a mobile device. The application is a user-interactive presentation of the data upon a visually perceivable display of the mobile device.

An embodiment of the present invention is a system for use in conjunction with a mobile device. The system includes a pre-processor configured to receive input data from a plurality of multimedia sources, generate Extensible Markup Language output links relating to the input data, and generate outputs comprising at least one of images, thumbnails, and rich media. The outputs are assembled into a mobile device application.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a block diagram of a multimedia system for mobile devices according to an embodiment of the present invention;

FIG. 2 is an example presentation of a title portion of a software-based application generated by the system of FIG. 1;

FIG. 3 is an example presentation of a table of contents portion of a software-based application generated by the system of FIG. 1;

FIG. 4 is an example presentation of a list of slides of a software-based application generated by the system of FIG. 1;

FIG. 5 is an example presentation of slide of a software-based application generated by the system of FIG. 1; and

FIG. 6 shows a magnified view of a portion of the example slide of FIG. 5.

### DETAILED DESCRIPTION

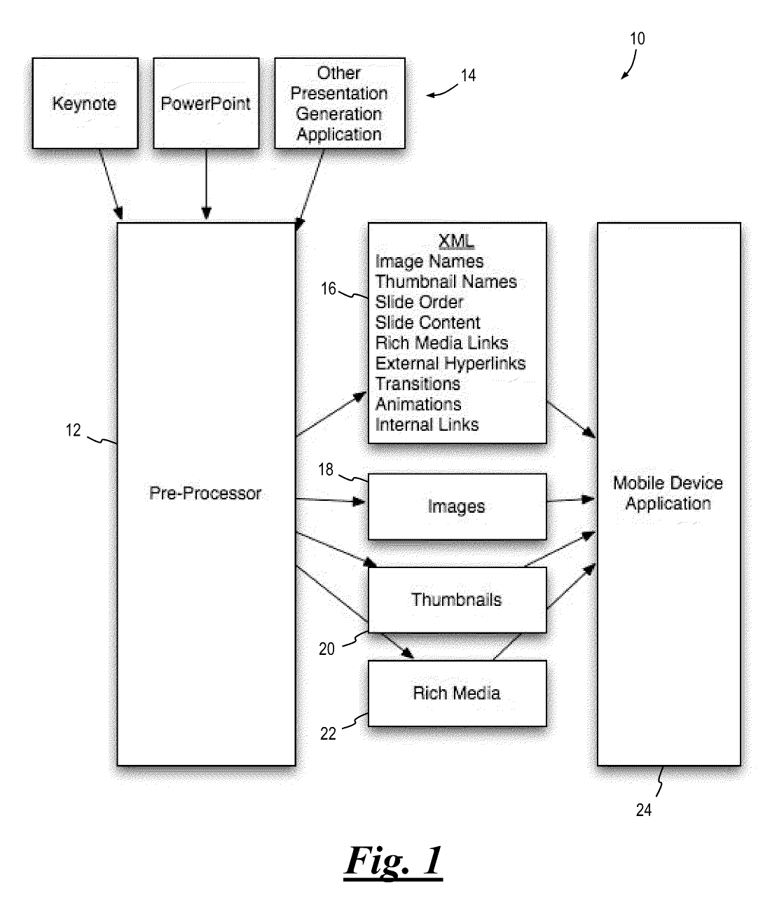

The general arrangement of a system 10 for use in conjunction with a mobile device is shown in FIG. 1. System 10 includes a pre-processor 12 that receives as input 14 data from a variety of types of multimedia sources. Pre-processor 10 generates Extensible Markup Language (XML) output links 16 relating to input data 14. Additional output data generated by pre-processor 12 includes images 18, thumbnails 20 (i.e., reduced-size versions of images) and rich media 22 that may include text, audio, video and animation in an interactive form. These outputs are assembled into a mobile device application 24.

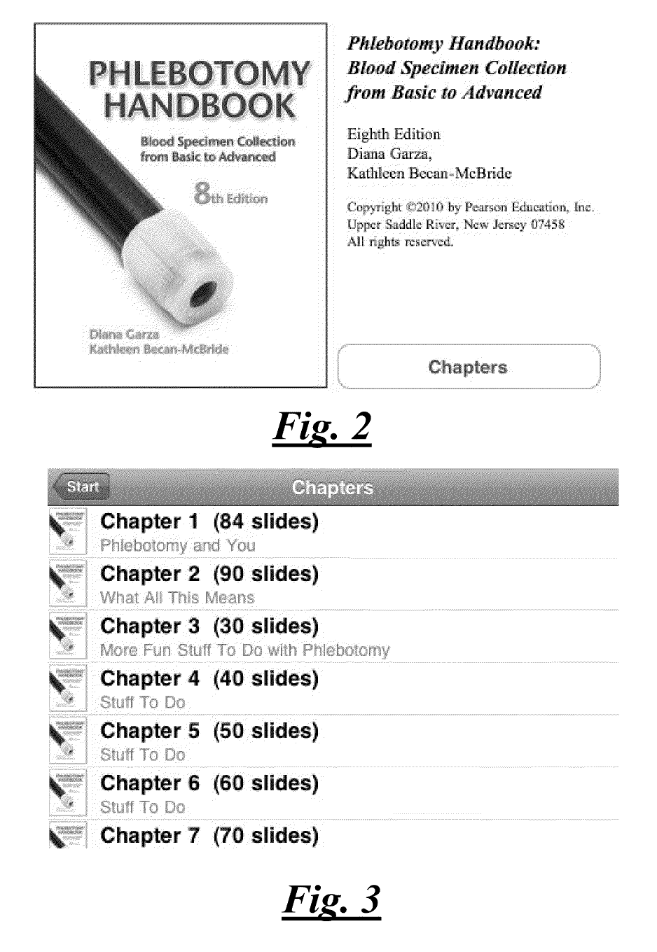

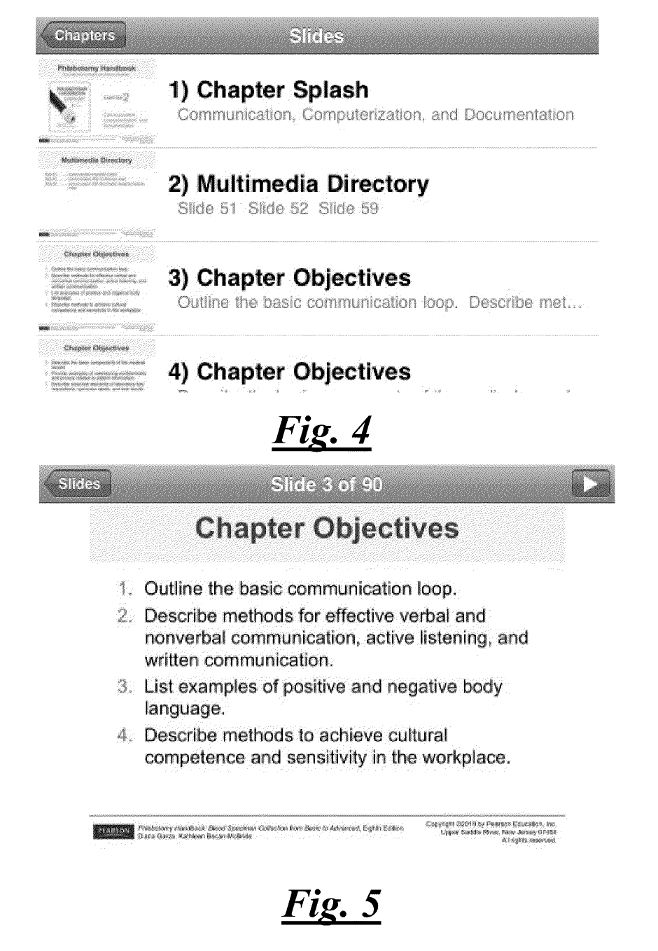

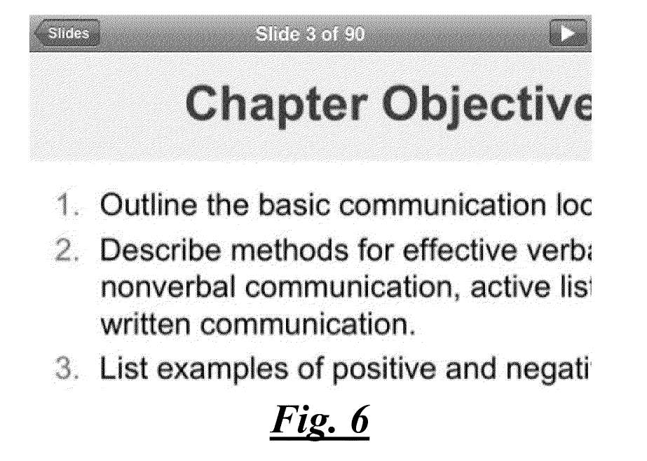

As a non-limiting example, input data 14 may be a series of study aids for a textbook, such as slides containing ancillary information, photographs, diagrams, animations, and so on intended to augment the material presented in the textbook. Preprocessor 12 utilizes the input data 14 in the manner previously described to generate the study aids in the form of an application that is downloadable into a mobile device such as a mobile telephone or a PDA. The study aids are organized and arranged to correspond to the arrangement of the textbook. Non-limiting example visually perceivable images that may appear upon a display of the mobile device are shown in FIGS. 2 through 6.

The present invention may be used or adapted to be used with any mobile telephone, portable media player, mobile computing device or personal digital assistant now known or later developed. An example mobile telephone includes so-called “smart phones” having computing capability, such as the iPhone® produced by Apple, Inc. of Cupertino, Calif. A non-limiting example portable media player is the iPod® and iPod Touch®, also produced by Apple, Inc. Likewise, a non-limiting example mobile computing device is the iPad®, produced by Apple, Inc.

While this invention has been shown and described with respect to a detailed embodiment thereof, it will be understood by those skilled in the art that changes in form and detail thereof may be made without departing from the scope of the claims of the invention.

What is claimed is:

1. A system for use in conjunction with a mobile device, comprising:
a pre-processor configured to:
receive input data from a plurality of multimedia sources;
generate Extensible Markup Language output links relating to the input data; and
generate outputs comprising at least one of images, thumbnails, and rich media,
said outputs being assembled into a mobile device application.

2. The system of claim 1 wherein the images, thumbnails, and rich media includes at least one of text, audio, video and animation in an interactive form.
